(19) United States
(12) Patent Application Publication
(10) Pub. No.: US 2026/0113505 A1
(43) Pub. Date: Apr. 23, 2026

(54) AUTOMATED ANALYSIS AND DYNAMIC SELECTION (CREATION) OF HIGH QUALITY SUPPLEMENTAL CONTENT FOR USER ENGAGEMENT OPTIMIZATION

(71) Applicant: Roku, Inc., San Jose, CA (US)

(72) Inventors: Poornima CHOZHIYATH RAMAN, San Jose, CA (US); Aravindkumar ILANGOVAN, Santa Clara, CA (US); Nima RAD, San Francisco, CA (US); Rupinder SINGH, San Jose, CA (US); Shankar SINGH, Bengaluru (IN); Iaroslav ZAITSEV, Pleasanton, CA (US); Amit VERMA, Sunnyvale, CA (US)

(73) Assignee: Roku, Inc., San Jose, CA (US)

(21) Appl. No.: 19/196,382

(22) Filed: May 1, 2025

Related U.S. Application Data
(63) Continuation-in-part of application No. 18/920,422, filed on Oct. 18, 2024.

(51) Int. Cl. H04N 21/431; H04N 21/81

(52) U.S. Cl. CPC H04N 21/4316; H04N 21/8126

(57) ABSTRACT

Disclosed herein are system, apparatus, article of manufacture, method and/or computer program product embodiments, and/or combinations and sub-combinations thereof, for automatic analysis and dynamic selection or creation of high quality supplemental content for a program (e.g., movies and TV shows) to maximize user engagement and the consumption of the media stream content by users. An example embodiment operates by using different machine learning (ML) models and large language models (LLMs) on existing supplemental content for the program to extract potential engaging features. The embodiment then conducts multivariate testing on the extracted potential engaging features to identify engaging features that improve user engagement for a user or a group of users. Based on the identified engaging features, the embodiment then selects high quality supplemental content from the video stream or alternatively creates high quality supplemental content using artificial intelligence (AI) when no high quality supplemental content exists for the video stream.

### CROSS-REFERENCE TO RELATED APPLICATIONS

This application is a continuation-in-part (CIP) of U.S. patent application Ser. No. 18/920,422, filed Oct. 18, 2024, which is hereby incorporated by reference in its entirety.

### FIELD

This disclosure is generally directed to automatically determining optimal supplemental content for a media stream menu interface, and more particularly to automatically determining optimal supplemental content from a media stream using automated content recognition (ACR) and machine learning/artificial intelligence.

### BACKGROUND

A content provider often wants to ensure that users who are potentially consuming their content actually consume their content through an advertisement or other supplemental content associated with the content and presented in a menu interface. For example, when presented with a supplemental content optimized for enticing the user, the user may be more motivated to click on and watch the media stream. By contrast, the user may be less likely to click on and watch the media stream if the supplemental content is unappealing to the user. Thus, there is a need to automatically determine optimal supplemental content to insert into a media stream menu interface to maximize the consumption of the media stream content by users.

Moreover, existing approaches often fail to provide a supplemental content that is optimally engaging to the user. For example, existing approaches rely on supplemental content provided by the content creator and can be overly generalized or otherwise unappealing to the user. For example, a user may be more likely to click on and watch a media stream based on supplemental content that has been carefully extracted and determined to be more likely to entice a user to watch a particular media stream.

### SUMMARY

Provided herein are system, apparatus, article of manufacture, method and/or computer program product embodiments, and/or combinations and sub-combinations thereof, for determining optimal supplemental content for a media stream menu interface to maximize the consumption of the media stream content by users. In other words, optimal supplemental content can be supplemental content that can invoke enough intrigue in a user to encourage the user to consume the associated media stream.

Various embodiments of the disclosure relate to a computer-implemented method for generating optimal supplemental content in a media stream menu interface display. In some embodiments, the method can include calculating, by at least one computer processor, a relative conversion rate, wherein the relative conversion rate is configured to predict a conversion rate for a potential optimal supplemental content, identifying, by the at least one computer processor, a characteristic of potential optimal supplemental content items in a media stream, predicting, by the at least one computer processor, the relative conversion rate for the potential optimal supplemental content items based on the characteristic identified by the at least one computer processor, building, by the at least one computer processor, a random sample of potential optimal supplemental content items from the media stream having a predicted relative conversion rate greater than a predetermined value, storing the random sample of potential optimal supplemental content items in a memory connected to the at least one computer processor, calculating, by the at least one computer processor, a relative conversion rate threshold value, wherein the relative conversion rate threshold value comprises a value less than a maximum relative conversion rate value, clustering, by the at least one computer processor, the potential optimal supplemental content items according to the characteristic identified by the at least one computer processor and having a relative conversion rate value greater than the relative conversion rate threshold value, sorting, by the at least one computer processor, the potential optimal supplemental content items having the relative conversion rate value greater than the relative conversion rate threshold value according to the identified characteristic of the potential optimal supplemental content, storing, by the at least one computer processor, a cluster of potential optimal supplemental content items in the memory according to the identified characteristic of the potential optimal supplemental content, selecting, by the at least one computer processor, a subset of media devices from a plurality of media devices based on one or more characteristics of the plurality of media devices and a relation between one or more characteristics of the subset of media devices and the relative conversion rate of the potential optimal supplemental content, and transmitting the cluster of images to the subset of media devices.

Further embodiments of the disclosure relate to a system for determining an optimal supplemental content from a media stream. The system can include one or more memories and at least one processor coupled to at least one of the memories and configured to perform the operations recited above.

Additional embodiments of the disclosure relate to a computer-implemented method for generating a supplemental content in a live stream media menu interface. The method can include extracting, by at least one computer processor, a closed-caption file embedded in a media stream, identifying, by the at least one computer processor, a characteristic of the media stream based on the closed-caption file, building, by the at least one computer processor, a random sample of potential supplemental content items from the media stream, storing the random sample of potential supplemental content items in a memory connected to the at least one computer processor, clustering, by the at least one computer processor, the potential supplemental content items according to the characteristic identified by the at least one computer processor, sorting, by the at least one computer processor, the potential supplemental content items, storing, by the at least one computer processor, a cluster of potential supplemental content items in the memory according to the identified characteristic of the potential supplemental content, selecting, by the at least one computer processor, a subset of media devices from a plurality of media devices based on one or more characteristics of the plurality of media devices, and transmitting the cluster of images to the subset of media devices.

In some embodiments, the optimal supplemental content item is an image, a still frame, or a content clip from the media stream and/or from a live media stream. In some embodiments, the relative conversion rate comprises a rate of user clicks on the selected content based on the potential optimal supplemental content. In some embodiments, the predetermined characteristic comprises content genre, content personality, content director, content subject matter, content time length, content country of origin, image quality, image theme, image sentiment, or any combination thereof. In some embodiments, the selecting comprises selecting the subset of media devices based on historical playback information. In some embodiments, the calculating the relative conversion rate comprises dividing an existing conversion rate by an average conversion rate based on the existing supplemental content, wherein the average conversion rate based on the existing supplemental content comprises an average across all tracked existing supplemental content. In some embodiments, the methods can further include receiving an indication from each media device of the subset of media devices that specifies whether the respective media device positioned the potential optimal supplemental content in the media stream menu interface. In some embodiments, the methods can further include determining, by a large language model embedded in the computer processor, characteristics of an audio file embedded in the media stream and/or generating, by the large language model embedded in the at least one computer processor, a closed-caption file based on the audio file.

Further embodiments of the disclosure relate to a computer-implemented method for selecting or generating high quality supplemental content for a program. In some embodiments, the method can include in response to determining, by at least one computer processor, a quality of at least one of supplemental content items exceeds a predetermined supplemental content quality threshold, identifying a first plurality of supplemental content items having a quality that is greater than the predetermined quality threshold, analyzing using at least one of machine learning (ML) models or large language models (LLMs), the first plurality of identified supplemental content items, extracting using the at least one of the ML models or the LLMs, a first plurality of features from the first plurality of identified supplemental content items based on automatic content recognition, categorizing the first plurality of features into a first plurality of feature categories, presenting to a plurality of users a second plurality of the supplemental content items associated with the first plurality of features, the second plurality of the supplemental content items being a subset of the first plurality of the supplemental content items, the plurality of users being selected based on a predefined standard, calculating a user engagement metric for each of the first plurality of feature categories based on the presenting, wherein the user engagement metric for a feature category represents user engagement in response to being presented a supplemental content item associated with the feature category, identifying a subset of the first plurality of feature categories for the plurality of users based on a predetermined user engagement metric threshold, and transmitting supplemental content items associated with features belonging to the subset of the first plurality of feature categories to media devices associated with the plurality of users.

Further embodiments of the disclosure relate to a system for selecting or generating high quality supplemental content for a program. The system can include one or more memories and at least one processor coupled to at least one of the memories and configured to perform the operations recited above in paragraph [0010].

Further embodiments of the disclosure relate to a non-transitory computer-readable medium having instructions stored thereon that, when executed by at least one computing device, cause the at least one computing device to perform the operations recited above in paragraph.

### BRIEF DESCRIPTION OF THE FIGURES

The accompanying drawings are incorporated herein and form a part of the specification.

FIG. 1A illustrates a block diagram of a multimedia environment, according to some embodiments.

FIG. 1B illustrates a block diagram of a streaming media device, according to some embodiments.

FIG. 2 illustrates an example computer system useful for implementing various embodiments.

FIG. 3 illustrates a block diagram of a system, according to some embodiments.

FIG. 4 is a flowchart illustrating a process for automatically determining an optimal supplemental content to insert into a media stream menu interface, according to some embodiments.

FIG. 5 is a flowchart illustrating a process for automatically determining an optimal supplemental content to insert into a media stream menu interface, according to some embodiments.

FIG. 6 is a flowchart illustrating a process for automatically analyzing and dynamically selecting high quality supplemental content for user engagement optimization, according to some embodiments.

FIG. 7 is a flowchart illustrating a process for automatically analyzing and dynamically generating high quality supplemental content for user engagement optimization, according to some embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, article of manufacture, method and/or computer program product embodiments, and/or combinations and sub-combinations thereof, for determining optimal supplemental content for a media stream menu interface to maximize the consumption of the media stream content by users.

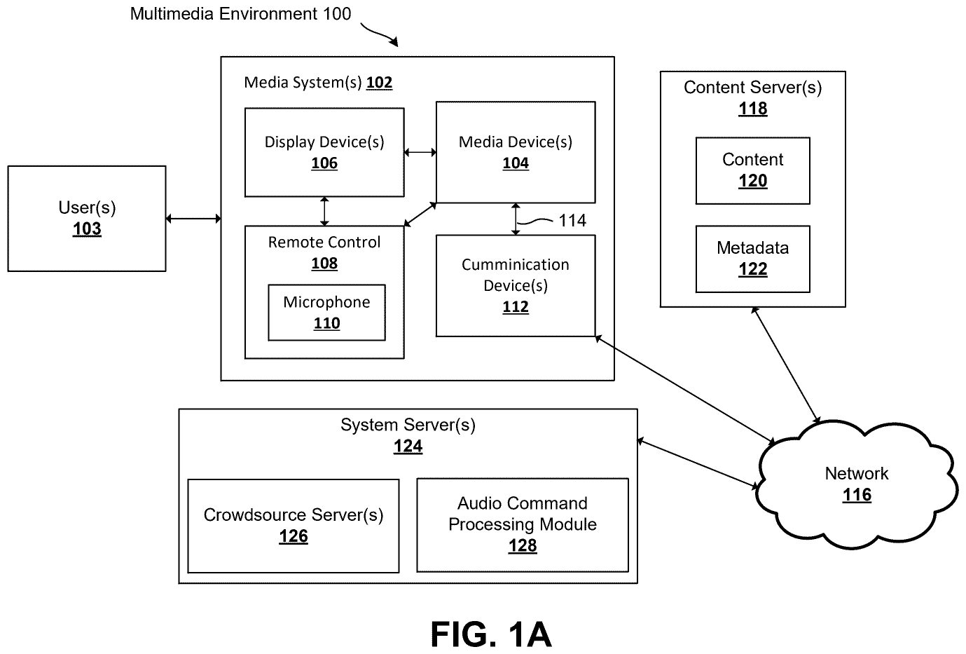

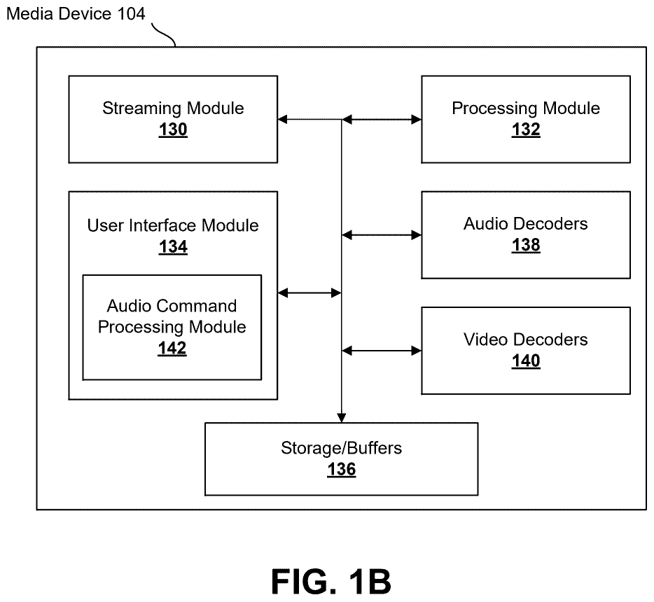

Various embodiments of this disclosure can be implemented using and/or can be part of a multimedia environment 100 shown in FIG. 1A, in some embodiments. It is noted, however, that multimedia environment 100 is provided solely for illustrative purposes, and is not limiting. Embodiments of this disclosure can be implemented using and/or can be part of environments different from and/or in addition to the multimedia environment 100, as will be appreciated by persons skilled in the relevant art(s) based on the teachings contained herein. An example of the multimedia environment 100 shall now be described.

### Multimedia Environment

FIG. 1A illustrates a block diagram of a multimedia environment 100, according to some embodiments. In a non-limiting example, multimedia environment 100 can be directed to streaming media. However, this disclosure is applicable to any type of media (instead of or in addition to streaming media), as well as any mechanism, means, protocol, method and/or process for distributing media.

The multimedia environment 100 can include one or more media systems 102. A media system 102 could represent a family room, a kitchen, a backyard, a home theater, a school classroom, a library, a car, a boat, a bus, a plane, a movie theater, a stadium, an auditorium, a park, a bar, a restaurant, or any other location or space where it is desired to receive and play streaming content. User(s) 103 can operate with the media system 102 to select and consume content.

Each media system 102 can include one or more media devices 104 each coupled to one or more display devices 106. It is noted that terms such as “coupled,” “connected to,” “attached,” “linked,” “combined” and similar terms can refer to physical, electrical, magnetic, logical, etc., connections, unless otherwise specified herein.

Media device 104 can be a streaming media device, digital video disk (DVD) or BLU-RAY device, audio/video playback device, cable box, and/or digital video recording device, to name just a few examples. Display device 106 can be a monitor, television (TV), computer, smart phone, tablet, wearable (such as a watch or glasses), appliance, internet of things (IoT) device, and/or projector, to name just a few examples. In some embodiments, media device 104 can be a part of, integrated with, operatively coupled to, and/or connected to its respective display device 106.

Each media device 104 can be configured to communicate with a network 116 via a communication device 112. The communication device 112 can include, for example, a cable modem or satellite TV transceiver. The media device 104 can communicate with the communication device 112 over a link 114, wherein the link 114 can include wireless (such as WiFi) and/or wired connections.

In various embodiments, the network 116 can include, without limitation, wired and/or wireless intranet, extranet, Internet, cellular, Bluetooth, infrared, and/or any other short range, long range, local, regional, global communications mechanism, means, approach, protocol and/or network, as well as any combination(s) thereof.

Media system 102 can include a remote control 108. The remote control 108 can be any component, part, apparatus and/or method for controlling the media device 104 and/or display device 106, such as a remote control, a tablet, laptop computer, smartphone, wearable, on-screen controls, integrated control buttons, audio controls, or any combination thereof, to name just a few examples. In an embodiment, the remote control 108 wirelessly communicates with the media device 104 and/or display device 106 using cellular, Bluetooth, infrared, etc., or any combination thereof. The remote control 108 can include a microphone 110, which is further described below.

The multimedia environment 100 can include a plurality of content servers 118 (also called content providers, channels, or sources). Although only one content server 118 is shown in FIG. 1, in practice the multimedia environment 100 can include any number of content servers 118. Each content server 118 can be configured to communicate with network 116.

Each content server 118 can store content 120 and metadata 122. Content 120 can include any combination of music, videos, movies, TV programs, multimedia, images, still pictures, text, graphics, gaming applications, advertisements, programming content, public service content, government content, local community content, software, and/or any other content or data objects in electronic form.

In some embodiments, metadata 122 comprises data about content 120. For example, metadata 122 can include associated or ancillary information indicating or related to writer, director, producer, composer, artist, actor, summary, chapters, production, history, year, trailers, alternate versions, related content, applications, and/or any other information pertaining or relating to the content 120. Metadata 122 can also or alternatively include links to any such information pertaining or relating to the content 120. Metadata 122 can also or alternatively include one or more indexes of content 120, such as but not limited to a trick mode index.

The multimedia environment 100 can include one or more system servers 124. The system servers 124 can operate to support the media devices 104 from the cloud. It is noted that the structural and functional aspects of the system servers 124 can wholly or partially exist in the same or different ones of the system servers 124.

The media devices 104 can exist in thousands or millions of media systems 102. Accordingly, the media devices 104 can lend themselves to crowdsourcing embodiments and, thus, the system servers 124 can include one or more crowdsource servers 126.

For example, using information received from the media devices 104 in the thousands and millions of media systems 102, the crowdsource server(s) 126 can identify similarities and overlaps between closed captioning requests issued by different users 103 watching a particular movie. Based on such information, the crowdsource server(s) 126 can determine that turning closed captioning on can enhance users' 103 viewing experience at particular portions of the movie (for example, when the soundtrack of the movie is difficult to hear), and turning closed captioning off can enhance users' 103 viewing experience at other portions of the movie (for example, when displaying closed captioning obstructs critical visual aspects of the movie). Accordingly, the crowdsource server(s) 126 can operate to cause closed captioning to be automatically turned on and/or off during future streamings of the movie.

The system servers 124 can also include an audio command processing module 128. As noted above, the remote control 108 can include a microphone 110. The microphone 110 can receive audio data from users 103 (as well as other sources, such as the display device 106). In some embodiments, the media device 104 can be audio responsive, and the audio data can represent verbal commands from the user 103 to control the media device 104 as well as other components in the media system 102, such as the display device 106.

In some embodiments, the audio data received by the microphone 110 in the remote control 108 is transferred to the media device 104, which is then forwarded to the audio command processing module 128 in the system servers 124. The audio command processing module 128 can operate to process and analyze the received audio data to recognize the user's 103 verbal command. The audio command processing module 128 can then forward the verbal command back to the media device 104 for processing.

In some embodiments, the audio data can be alternatively or additionally processed and analyzed by an audio command processing module 142 in the media device 104 (see FIG. 1B). The media device 104 and the system servers 124 can then cooperate to pick one of the verbal commands to process (either the verbal command recognized by the audio command processing module 128 in the system servers 124, or the verbal command recognized by the audio command processing module 142 in the media device 104).

### Media Device

FIG. 1B illustrates a block diagram of an example media device 104, according to some embodiments. Media device 104 can include a streaming module 130, processing module 132, storage/buffers 136, and a user interface module 134. As described above, the user interface module 134 can include the audio command processing module 142.

The media device 104 can also include one or more audio decoders 138 and one or more video decoders 140.

Each audio decoder 138 can be configured to decode audio of one or more audio formats, such as but not limited to AAC, HE-AAC, AC3 (Dolby Digital), EAC3 (Dolby Digital Plus), WMA, WAV, PCM, MP3, OGG GSM, FLAC, AU, AIFF, and/or VOX, to name just some examples.

Similarly, each video decoder 140 can be configured to decode video of one or more video formats, such as but not limited to MP4 (mp4, m4a, m4v, f4v, f4a, m4b, m4r, f4b, mov), 3GP (3gp, 3gp2, 3g2, 3gpp, 3gpp2), OGG (ogg, oga, ogv, ogx), WMV (wmv, wma, asf), WEBM, FLV, AVI, QuickTime, HDV, MXF (OPla, OP-Atom), MPEG-TS, MPEG-2 PS, MPEG-2 TS, WAV, Broadcast WAV, LXF, GXF, and/or VOB, to name just some examples. Each video decoder 140 can include one or more video codecs, such as but not limited to H.263, H.264, H.265, AVI, HEV, MPEG1, MPEG2, MPEG-TS, MPEG-4, Theora, 3GP, DV, DVCPRO, DVCPRO, DVCProHD, IMX, XDCAM HD, XDCAM HD422, and/or XDCAM EX, to name just some examples.

Now referring to both FIGS. 1A and 1B, in some embodiments, the user 103 can interact with the media device 104 via, for example, the remote control 108. For example, the user 103 can use the remote control 108 to interact with the user interface module 134 of the media device 104 to select content, such as a movie, TV show, music, book, application, game, etc. The streaming module 130 of the media device 104 can request the selected content from the content server(s) 118 over the network 116. The content server(s) 118 can transmit the requested content to the streaming module 130. The media device 104 can transmit the received content to the display device 106 for playback to the user 103.

In streaming embodiments, the streaming module 130 can transmit the content to the display device 106 in real time or near real time as it receives such content from the content server(s) 118. In non-streaming embodiments, the media device 104 can store the content received from content server(s) 118 in storage/buffers 136 for later playback on display device 106.

### Example Computer System

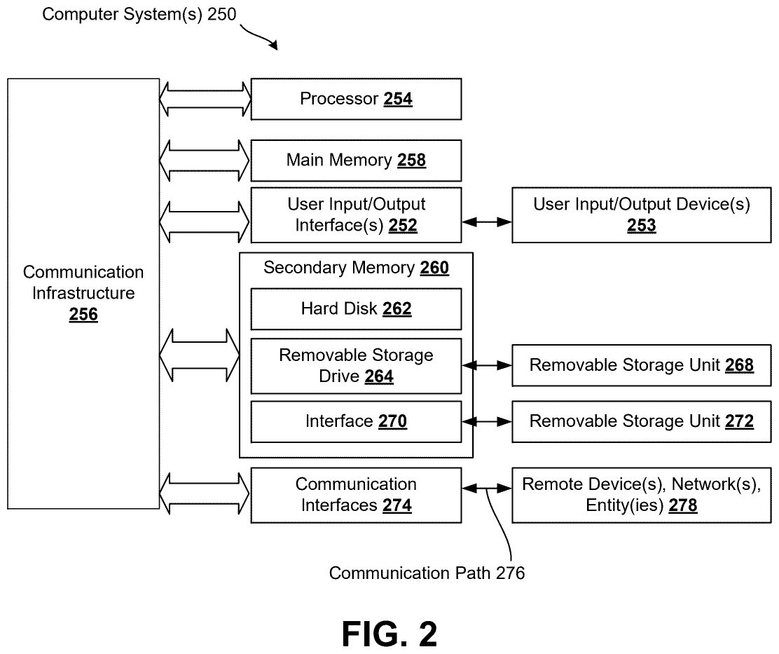

Various embodiments can be implemented, for example, using one or more well-known computer systems, such as a computer system 250 shown in FIG. 2. For example, the media device 104 can be implemented using combinations or sub-combinations of the computer system 250. Also or alternatively, one or more computer systems 250 can be used, for example, to implement any of the embodiments discussed herein, as well as combinations and sub-combinations thereof.

Computer system 250 can include one or more processors (also called central processing units, or CPUs), such as a processor 254. Processor 254 can be connected to a communication infrastructure (or bus) 256.

Computer system 250 can also include user input/output device(s) 253, such as monitors, keyboards, pointing devices, etc., which can communicate with communication infrastructure 256 through user input/output interface(s) 252.

One or more of processors 254 can be a graphics processing unit (GPU). In an embodiment, a GPU can be a processor that is a specialized electronic circuit designed to process mathematically intensive applications. The GPU can have a parallel structure that is efficient for parallel processing of large blocks of data, such as mathematically intensive data common to computer graphics applications, images, videos, etc.

Computer system 250 can also include a main or primary memory 258, such as random access memory (RAM). Main memory 258 can include one or more levels of cache. Main memory 258 can have stored therein control logic (i.e., computer software) and/or data.

Computer system 250 can also include one or more secondary storage devices or memory 260. Secondary memory 260 can include, for example, a hard disk drive 262 and/or a removable storage device or drive 264. Removable storage drive 264 can be a floppy disk drive, a magnetic tape drive, a compact disk drive, an optical storage device, tape backup device, and/or any other storage device/drive.

Removable storage drive 264 can interact with a removable storage unit 268. Removable storage unit 268 can include a computer usable or readable storage device having stored thereon computer software (control logic) and/or data. Removable storage unit 268 can be a floppy disk, magnetic tape, compact disk, DVD, optical storage disk, and/any other computer data storage device. Removable storage drive 264 can read from and/or write to removable storage unit 268.

Secondary memory 260 can include other means, devices, components, instrumentalities or other approaches for allowing computer programs and/or other instructions and/or data to be accessed by computer system 250. Such means, devices, components, instrumentalities or other approaches can include, for example, a removable storage unit 272 and an interface 270. Examples of the removable storage unit 272 and the interface 270 can include a program cartridge and cartridge interface (such as that found in video game devices), a removable memory chip (such as an EPROM or PROM) and associated socket, a memory stick and USB or other port, a memory card and associated memory card slot, and/or any other removable storage unit and associated interface.

Computer system 250 can further include a communication or network interface 274. Communication interface 274 can enable computer system 250 to communicate and interact with any combination of external devices, external networks, external entities, etc. (individually and collectively referenced by reference number 278). For example, communication interface 274 can allow computer system 250 to communicate with external or remote devices 278 over communications path 276, which can be wired and/or wireless (or a combination thereof), and which can include any combination of LANs, WANs, the Internet, etc. Control logic and/or data can be transmitted to and from computer system 250 via communication path 276.

Computer system 250 can also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof.

Computer system 250 can be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 250 can be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas can be used, either exclusively or in combination with known or open standards.

In some embodiments, a tangible, non-transitory apparatus or article of manufacture comprising a tangible, non-transitory computer useable or readable medium having control logic (software) stored thereon can also be referred to herein as a computer program product or program storage device. This includes, but is not limited to, computer system 250, main memory 258, secondary memory 260, and removable storage units 268 and 272, as well as tangible articles of manufacture embodying any combination of the foregoing. Such control logic, when executed by one or more data processing devices (such as computer system 250 or processor(s) 254), can cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 2. In particular, embodiments can operate with software, hardware, and/or operating system implementations other than those described herein.

Automatic Determination of an Optimal Supplemental Content for Placement into a Media Stream Menu interface

Referring to FIGS. 1A, 1B, 2, and 3, a content 320 source (e.g., content server 318) can transmit a media stream to a media system 302 (e.g., media device 304 and/or display device 306 that can be connected via link 314) through network 316. The content server 318 can insert supplemental content (e.g., an image, a clip, etc.) into the media stream menu interface. In some embodiments, the media stream menu interface can include a home screen of a media streaming service (e.g., media streaming applications' menu screen). To maximize the consumption of content 320 by a user 303 of the media device 304, content server 318 can determine the optimal supplemental content (e.g., an image, a clip, etc.) to insert into the media stream menu interface. In some embodiments, the content server 318 determines the optimal supplemental content to place into the media stream menu interface using various characteristics derived from various machine learning and/or artificial intelligence models.

In some embodiments, processing module 132 and/or content server 318 can be configured to perform the methods described herein. In further embodiments, the methods described herein can be performed in a cloud computing environment. For example, content server 318 can be configured to perform a computer-implemented method for generating optimal supplemental content for use in the menu interface screen of a media streaming service. In some embodiments, as used herein, “supplemental content” refers to images (e.g., still frames) or short clips (e.g., a collection of continuous frames) extracted from a media stream (e.g., a movie, a television show, a live broadcast, etc.) and shown adjacent to the title of the media stream content 320 to entice viewers to click on and watch the media stream. For example, the methods described herein can extract optimal supplemental content from the media stream based on the viewing history of a user 303.

In some embodiments, the content server 318 and/or the processing module 132 can be configured to calculate a relative conversion rate for optimal supplemental content based on the conversion rate for existing supplemental content. As used herein, a “conversion rate” is the rate at which user 303 views the supplemental content and watches the associated media stream in response to viewing the supplemental content. In other words, the conversion rate is how often a particular supplemental content item entices a user to watch the media stream from which the supplemental content was extracted. In some embodiments, the relative conversion rate Cᵣₑₗ can be defined as dividing an existing conversion rate for an existing supplemental content (e.g., artwork) Aᵢ by an average conversion rate based on the existing supplemental content Cⱼ, wherein the average conversion rate based on the existing supplemental content Cⱼ can be defined as an average across all tracked existing supplemental content, or

$$\begin{matrix}{C}_{r e l} = \frac{{A}_{i}}{{C}_{j}} , where \\ {C}_{j} = a v g ( {A}_{i} ) .\end{matrix}$$

In some embodiments, the content server 318 and/or the processing module 132 can track conversion rate data for existing supplemental content Aⱼ and store the conversion rate data for the existing supplemental content Aⱼ in storage 136, main memory 258, and/or secondary memory 260 shown in FIG. 2. In some embodiments, content server 318 and/or the processing module can calculate the average conversion rate based on the existing supplemental content Cⱼ and store the average conversion rate based on the existing supplemental content Cⱼ in, for example, storage 136. The content server 318 and/or processing module 132 can, as needed, extract the conversion rate data for the existing supplemental content Aᵢ and the average conversion rate based on the existing supplemental content Cⱼ from, for example, storage 136 to perform the relative conversion rate Cⱼ calculation.

For example, content server 318 can perform automatic content recognition (ACR) on the media stream, thereby identifying potential optimal supplemental content in the media stream. Content server 318 can then identify one or more potential optimal supplemental content items (e.g., frames and/or clips) in the media stream content 320 based on predetermined characteristics of the media stream. The predetermined characteristics can include, for example, content 320 genre, content 320 personality, content 320 director, content 320 subject matter, content 320 time length, content 320 country of origin, or any combination thereof. Content server 318 can then generate a set of features for the existing supplemental content. The set of features can include, for example, clip or blip recognition, face recognition, image/clip to text conversion, image/clip topic recognition, and/or image/clip tagging. In some embodiments, the generated features can be used to identify a plurality of potential optimal supplemental content images/clips embedded in the media stream. In some embodiments, the generated features can be stored in, for example, storage 136 by the processing module, or can be stored in the content server 318 as metadata 322.

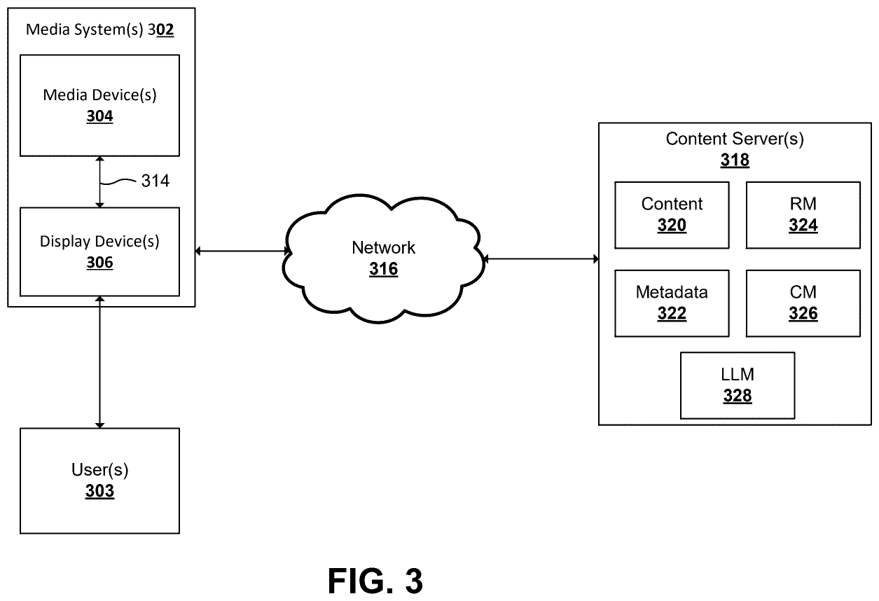

In some embodiments, the content server 318 and/or the processing module 132 can build a regression model 324 (referred to as “RM” in the example of FIG. 3) (e.g., a deep learning model, a random forest model, and/or a gradient boosted tree model) to analyze the potential optimal supplemental content items. In some embodiments, content server 318 and/or the processing module 132 can, by way of the regression model 324, predict a relative conversion rate for the potential optimal supplemental content. In some embodiments, predicting the relative conversion rate for the potential optimal supplemental content can alleviate issues related to particular supplemental content items having inflated conversion rates due to the supplemental content popularity and/or the supplemental content quality. For example, a supplemental content item containing a trending actor can be clicked on/selected preferentially due to the actor's popularity at the time. As such, the particular supplemental content item can have an unintended high conversion rate. The methods described herein are directed to providing optimal supplemental content that is agnostic to popularity trends and targeted to user 303. In other words, user's 303 content 320 consumption history, determined by the conversion rate of existing supplemental content, can be a variable considered by the regression model to predict the relative conversion rate for the potential optimal supplemental content item.

The regression model 324 can be used to distinguish the potential optimal supplemental content items per the characteristics of the potential optimal supplemental content items. For example, an image of a couple embracing can be categorized as a romance and/or romantic comedy, while a short clip of a high-speed pursuit can be categorized as one of action, suspense, drama, sports, or the like.

In some embodiments, content server 318 can assign tags to the potential optimal supplemental content items (e.g., data indicators associated with the potential optimal supplemental content that can indicate to content server 318 what characteristics are associated with the potential optimal supplemental content) based on categorization results from the regression model 324.

Content server 318 can perform ACR to identify scenes in the media stream that can be used as the optimal supplemental content (e.g., still frames and/or short video clips or shorts). ACR is a technology for identifying content 320 to be played on a media device (e.g., media device 304) or present within a media file. ACR can involve generating a unique fingerprint from the content 320 itself. The generated fingerprint can then be used to lookup the same or equivalent content 320 having the same fingerprint. Fingerprinting can be agnostic to content 320 format, codec, bit rate, and or compression techniques. This makes it possible to employ it across varying networks and channels. ACR can be implemented using various other techniques as would be appreciated by a person of ordinary skill in the art.

Existing approaches to inserting supplemental content into a media stream menu interface are often done manually. But manually inserting the supplemental content into a media stream is often time intensive and error prone. The content server 318 employing ACR to identify scene changes in the media stream solves these technological problems.

The content server 318 can perform ACR on the media stream to identify various types of potential optimal supplemental content. For example, the content server 318 can identify a locale/setting, an actors or actors, a display of emotion, or other types of potential optimal supplemental content that is indicative of the media stream content 320 as would be appreciated by a person of ordinary skill in the art.

After performing ACR on the media stream, the content server 318 can identify one or more potential optimal supplemental content items (e.g., a still frame and/or a short video clip) in the media stream based on the determined characteristics. Content server 318 can then store the potential optimal supplemental content items in main memory 258, secondary memory 260, and/or metadata 322. The one or more potential optimal supplemental content items can represent the genre, actor(s), director(s), setting, any combination thereof, or any other potential optimal supplemental content item that can both identify the content 320 in the media stream and entice the user to at least click on the media stream title.

After identifying potential optimal supplemental content items (e.g., still frames and/or short clips) in the media stream (whether based on the performance of ACR on the media stream, or using another technique as would be appreciated by a person of ordinary skill in the art), the content server 318 can build the regression model 324 described previously, the regression model 324 configured to predict the relative conversion rate for the potential optimal supplemental content.

In some embodiments, predicting the relative conversion rate can be performed by the content server 318 or the processing module 132. Content server 318 and/or processing module 132 can compare, by way of the regression model 324, the conversion rate of existing supplemental content, along with the identifying features of the existing supplemental content to the identifying features of the potential optimal supplemental content. The content server 318 and/or the processing module 132 can then assign a relative conversion rate to the potential optimal supplemental content based on the comparison. Once assigned a relative conversion rate, the regression model 324, by way of content server 318, can store the relative conversion rate in, for example, storage 136.

In some embodiments, content server 318 and/or the processing module 132 can determine a lower threshold relative conversion rate used to select optimal supplemental content items from the plurality of potential optimal supplemental content items. For example, the predetermined lower threshold conversion rate (e.g., a minimum relative conversion rate) can be 2%. Accordingly, in some embodiments, any potential optimal supplemental content being assigned a relative conversion rate value greater than or equal to the lower threshold value can be marked as optimal supplemental content by the content server 318 and/or the processing module 132 by way of the regression model 324. Marking the potential optimal supplemental content item can be performed by adding a tag (e.g., a line of data showing an identifying characteristic of the potential optimal supplemental content item) to the potential optimal supplemental content item file and storing the potential optimal supplemental content item file in, for example, storage 136.

Based on the results of the regression model 324 assigning a relative conversion rate value greater than or equal to the lower threshold conversion rate value, the content server 318 can build a random sample of optimal supplemental content from the images having the relative conversion rate value greater than or equal to the lower threshold conversion rate value in the media stream and store the random sample of potential optimal supplemental content in the memory (e.g., storage 136 and/or content server 318).

In some embodiments, once the random sample is built, the content server 318 and/or the processing module 132 can build a clustering model 326 (referred to as “CM” in the example of FIG. 3) configured to sort the potential supplemental content according to predetermined characteristics. For example, the predetermined characteristics can include content 320 genre, content 320 personality, content 320 director, content 320 subject matter, content 320 time length, content 320 country of origin, or any combination thereof, that is stored as a tag in the optimal supplemental content media file located in storage 136 and/or content server 318.

In some embodiments, the clustering model 326 can be a k-means clustering algorithm and/or a hierarchical agglomerative clustering (HAC) algorithm. The content server 318 and/or the processing module 132 can employ the clustering model 326 to build clusters of optimal supplemental content having similar characteristics according to the predetermined characteristics recited above. The clusters can be stored in the memory (e.g., storage 132 and/or metadata 322 in content server 318) such that optimal supplemental content can be retrieved from the memory and transmitted to media device 304 for output to the media stream menu interface (e.g., the media streaming service menu screen) in the example of the optimal supplemental content cluster being built in content server 318. Optionally, in some embodiments the optimal supplemental content clusters can be built and stored in media device 304.

In some embodiments, content server 318 can then transmit the optimal supplemental content having threshold values greater than or equal to the lower threshold value to at least a subset of selected media devices 304 via network 316. For example, the subset of media devices 304 can be selected according to predetermined characteristics including geographical location, historical playback information, existing conversion rates, account holder demographics, or any combination thereof.

It is noted that the structural and functional aspects of the content server 318 can wholly or partially exist in the same or different ones of other content 320 sources or servers. For example, the structural and functional aspects of the content server 318 can wholly or partially exist in a system server 124.

As discussed above, the content server 318 can transmit a media stream to a media device 304 via network 316. The media stream can be any type of media including, but not limited to, video, audio, and/or audio-visual (A/V). The content server 318 can insert supplemental content into the media stream menu interface (e.g., a streaming service home screen). The supplemental content can be any type of content 320 including, but not limited to, individual still frames, still shots, short clips, or any combination thereof.

The content server 318 can select the plurality of media devices 304 based on media devices 304 residing in a particular geographic location (e.g., the country of Germany, a particular zip code, etc.) The content server 318 can select the plurality of media devices 304 based on the media devices 304 being active during a particular time of the day (e.g., 7:00 PM to 10:00 PM). The content server 318 can select the plurality of media devices 304 based on historical behavior of the users of the media devices 304 (e.g., historical playback information). For example, the content server 318 can select the plurality of media devices 304 based on the users of the media devices 304 historically streaming content 320 until the end of the content 320, e.g., a program, movie, or the like, in the media stream for a threshold amount of time (e.g., 90% of the time the user streams until the end of the content 320). The content server 318 can select the plurality of media devices 304 based on various other characteristics as would be appreciated by a person of ordinary skill in the art.

The content server 318 can measure the efficacies of the potential supplemental content items by receiving information from the plurality media devices 304 over network 316. For example, the content server 318 can receive an indication from each media device 304 of the plurality media devices 304. The indication can specify whether a user of the respective media device 304 watched or listened through the selected content 320 based on the optimal supplemental content pushed to the media stream menu interface on each media device 304.

The content server 318 can determine the optimal supplemental content item among the plurality of potential optimal supplemental content items from the media stream based on the measured efficacies of the potential optimal supplemental content items. For example, content server 318 can determine that the optimal supplemental content item is a first optimal supplemental content item because the content 320 was streamed through by users more often than the content 320 represented by previously existing supplemental content. The content server 318 can further determine that the optimal supplemental content item is an optimal supplemental content item because the content 320 was streamed through by users for a threshold amount of time more than the content 320 represented by the previously existing supplemental content.

The content server 318 can select a particular one of many determined optimal supplemental content items clustered according the clustering model 326 described previously for transmission of supplemental content to media device(s) 304. For example, the content server 318 can select a determined optimal supplemental content item that generally represents the media stream content 320. In other words, the content server 318 can select a determined optimal supplemental content item that represents the media stream content 320 independent of any particular characteristics of a media device 304 (e.g., geographic location, time of day it is active, etc.).

The content server 318 can also select a particular determined optimal supplemental content item for transmission of the optimal supplemental content to media device(s) 304 based on a particular characteristic of media device(s) 304. For example, content server 318 can select an optimal supplemental content item that is determined optimal for media devices 304 located in a particular location (e.g., the country of Germany, a particular zip code, etc.). The content server 318 can also select an optimal supplemental content item that is determined optimal for media devices 304 active during a particular time of the day (e.g., 7:00 PM to 10:00 PM). The content server 318 can also select an optimal supplemental content item that is determined optimal for media devices 304 having users who historically watch or listen to the end of a media stream content 320 for a threshold amount of time (e.g., 90% of the time). The content server 318 can also select an optimal supplemental content item that is determined optimal for media devices 304 having users who stream the content 320 through the end of the content 320 for a threshold amount of time (e.g., more than 50% of the time). The content server 318 can select an optimal supplemental content item that is determined optimal for media devices 304 based on various other characteristics as would be appreciated by a person of ordinary skill in the art.

In some embodiments, one or more of RM 324, CM 326, and LLM 328 may be implemented locally at media device(s) 304. In some embodiments, functionality of RM 324, CM 326, and LLM 328 may be distributed between media device(s) 304 and content server(s) 318.

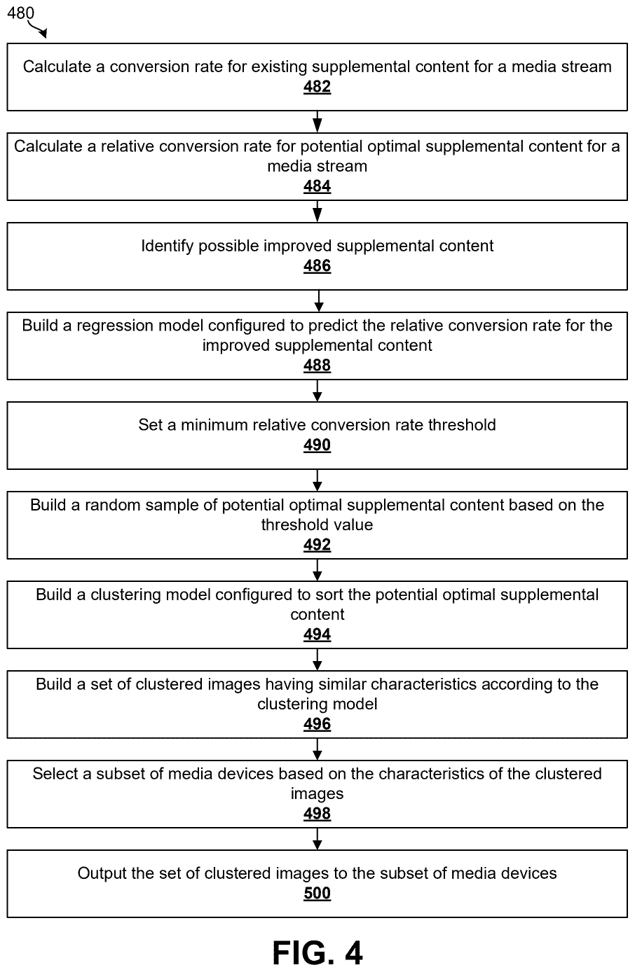

FIG. 4 illustrates a method 480 for automatically determining an optimal supplemental content item (e.g., a still frame and/or a short clip from a media stream content 320) to insert supplemental content into a media stream menu interface (e.g., a streaming service home screen) to maximize the consumption of the media stream content 320 by users, according to some embodiments. Method 480 can be performed by processing logic that can comprise hardware (e.g., circuitry, dedicated logic, programmable logic, microcode, etc.), software (e.g., instructions executing on a processing device), or a combination thereof. It is to be appreciated that not all steps can be needed to perform the disclosure provided herein. Further, some of the steps can be performed simultaneously, or in a different order than shown in FIG. 4, as will be understood by a person of ordinary skill in the art.

For illustrative and non-limiting purposes, method 480 shall be described with reference to FIGS. 1A, 1B, 2, and/or 3. However, method 480 is not limited to those examples.

In operation 482, content server 318 and/or processing module 132 can calculate a conversion rate for existing supplemental content. The existing supplemental content can be still frames and/or short clips provided by the content 320 creator(s), the streaming service providing the content 320 for streaming, or any source that will be understood by a person of ordinary skill in the art. The conversion rate can be a rate of user clicks on a particular media stream content 320 title based on the existing supplemental content. In other words, the conversion rate can exemplify how often a user clicks on a media stream content 320 title after viewing the supplemental content associated with the content 320 title.

In operation 484, content server 318 can calculate a relative conversion rate for potential optimal supplemental content as described previously. The relative conversion rate can be used to predict an optimal supplemental content item.

In operation 486, content server 318 can identify a plurality of potential supplemental content items (e.g., images, still frames, and/or clips) from within the media stream. The potential supplemental content items can represent possible frames or clips in the media stream for inserting optimal supplemental content into the media stream menu interface (e.g., a streaming service home screen). Each potential optimal supplemental content can offer higher consumption of the media stream content 320 by a user of a media device 304.

Content server 318 can identify the plurality of potential optimal supplemental content items in the media stream based on predetermined characteristics generated by content server 318. For example, content server 318 can identify potential supplemental content items in the media stream that can be indicative of the genre of the media stream content 320, actors portraying characters in the media stream content 320, locale or setting of the media stream content 320, any combination thereof, or any indicating characteristics that will be understood to a person of ordinary skill in the art. Content server 318 can then store the potential optimal supplemental content items in main memory 258, secondary memory 260, and/or metadata 322.

In operation 488, content server 318 can build a regression model 324 (e.g., a deep learning model, a random forest model, and/or a gradient boosted tree model). The content server 318 and/or processing module 132 can, by way of the regression model 324, predict a relative conversion rate for the potential optimal supplemental content. In some embodiments, predicting the relative conversion rate for the potential optimal supplemental content can alleviate issues related to particular supplemental content items having inflated conversion rates due to the supplemental content popularity and/or the supplemental content quality. In some embodiments, regression model 324 can predict the relative conversion rate for a potential optimal supplemental content item based on the conversion rate for an existing supplemental content item. For example, an existing content item can include a characteristic tag that is similar to a characteristic tag of the potential optimal supplemental content item. In some embodiments, determining content item to be optimal is based on the regression model employing such a shared variable in determining whether the potential optimal supplemental content item (e.g., an unknown variable) can be at least as effective in enticing a user to select the associated content as the existing supplemental content (e.g., a known variable). In other words, the regression model can use what is known about the existing supplemental content item to predict what is unknown about the potential optimal supplemental content item. In some embodiments, the variables include conversion rates associated with the tags provided to existing supplemental content items (e.g., known variables) and relative conversion rates associated with the tags provide to the potential optimal supplemental content items (e.g., the unknown variables). In doing so, the regression model can leverage what is known about the existing supplemental content items to predict the relative conversion rate(s) for the potential optimal supplemental content items.

The regression model 324 can be used to distinguish the potential optimal supplemental content items per the characteristics of the potential optimal supplemental content items. For example, an image of a couple embracing can be categorized as a romance and/or romantic comedy, while a short clip of a high-speed pursuit can be categorized as and one of action, suspense, drama, or the like.

In some embodiments, content server 318 can assign tags to the potential optimal supplemental content items (e.g., data indicators associated with the potential optimal supplemental content that can indicate to content server 318 what characteristics are associated with the potential optimal supplemental content) based on results from the regression model 324. For example, the tags can include information such as “action,” “romantic comedy,” “Morgan Freeman,” “a galaxy far, far away,” or “Steven Spielberg.” In other words, the potential optimal supplemental content value can be saved with a digital identifier that content server 318 can use to identify each potential optimal supplemental content item.

In operation 490, content server 318 can set a minimum threshold value for the relative conversion rate. In some embodiments, the minimum threshold value can represent a point at which a particular potential optimal supplemental content item can be expected to increase the conversion rate associated with a particular media device 304. For example, the minimum threshold value can be a value that is about 50% lower than a maximum relative conversion value calculated

In operation 492, content server 318 can build a random sample of potential optimal supplemental content based on the minimum threshold value. In some embodiments, the random sample can include any and/or all still frames from the media stream content 320. In some embodiments, the random sample can include clips from the media stream content 320 (e.g., short scenes, action sequences, romantic interludes, pivotal moments, etc.).

In operation 494, content server 318 can build a clustering model 326 configured to sort the potential optimal supplemental content. In some embodiments, content server 318 can read the tags and relative conversion rate value to select a potential optimal supplemental content item from the random sample of potential optimal supplemental content items.

In operation 496, content server 318, by way of the clustering model 326, can build a set of clustered potential optimal supplemental content items having similar characteristics according to the predetermined characteristics (e.g., genre, locale/setting, actor(s), director(s), etc.). The clustered potential optimal supplemental content items can serve as a supplemental content bundle from which content server 318 can extract and place the extracted supplemental content item in the media stream menu interface.

In operation 498, content server 318 can select a subset of media devices 304 based on the characteristics of the clustered potential optimal supplemental content items, as well as the characteristics of media devices 304. For example, media devices 304 selected to receive the potential optimal supplemental content can be selected based on historical playback information, geographical location, active times of the day (e.g., from 6:00 PM to 11:00 PM), or any combination thereof. Content server 318 can select media devices 304 based on various other characteristics as would be appreciated by a person of ordinary skill in the art. In some embodiments, content server 318 can select potential optimal supplemental content items (e.g., content items having the relative conversion rate greater than the threshold value) from different sets of clustered images. A content item may be determined to be optimal based on the regression model employing such a shared characteristic in determining whether the potential optimal supplemental content item (e.g., an unknown variable) can be at least as effective in enticing a user to select the associated content as the existing supplemental content (e.g., a known variable). For example, content server 318 can select a frame or short clip from a set of clustered images having an overlapping tag (e.g., a set of clustered images having a common tag directed to a locale or setting) that is similar to the set of clustered images when other tags, including genre, tone, director(s), etc., are different. In other words, content server 318 can extract a potential optimal supplemental content item from a cluster having a geographical tag such as “Atlanta” and a genre tag such as “comedy” even though the present set of clustered images includes a genre tag of “romance” and a geographical tag of “Atlanta.”

In operation 500, content server 318 can output the set of clustered images according to the relative conversion rate threshold to the subset of media devices 304. For example, after the subset of media devices 304 are selected based on the predetermined characteristics described previously, content server (and/or processing module 132) can send the potential optimal supplemental content item(s) to the selected media device(s) 304 for display in the media stream menu interface (e.g., a streaming service home screen). The outputted potential optimal supplemental content can be displayed in concert with the title of the media stream content 320 from which the potential optimal supplemental content item was extracted.

In some embodiments, content server 318 can receive an indication from each media device 304 of the subset of media devices 304 that specifies whether the respective media device 304 outputted the optimal supplemental content and positioned the potential optimal supplemental content item in the menu interface display.

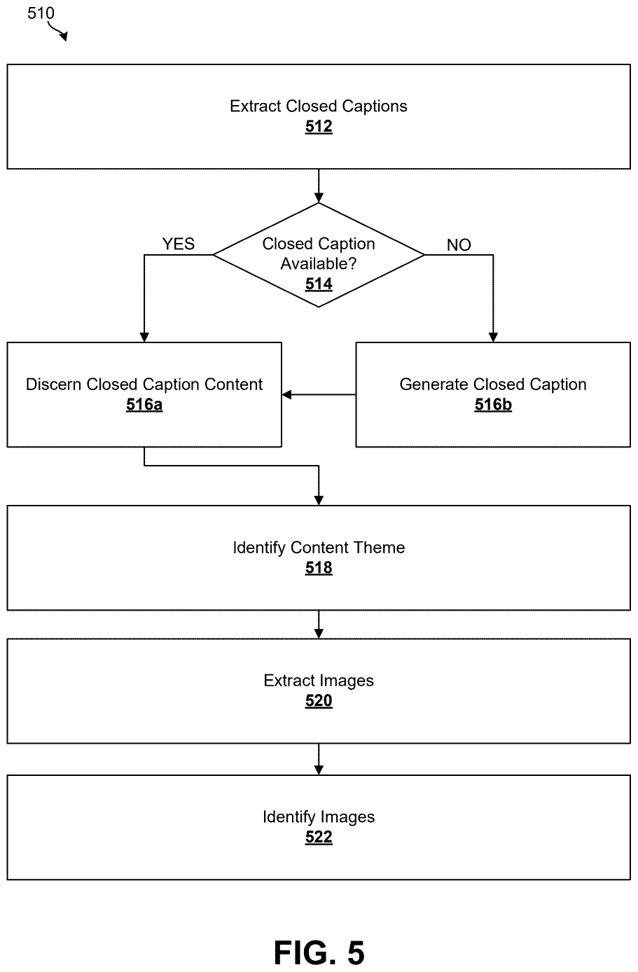

FIG. 5 illustrates a method 510 for automatically determining an optimal supplemental content item (e.g., a still frame and/or a short clip from a media stream content 320) to insert supplemental content into a media stream menu interface (e.g., a streaming service home screen) to maximize the consumption of the media stream content 320 by users, according to some embodiments. Method 510 can be performed by processing logic that can comprise hardware (e.g., circuitry, dedicated logic, programmable logic, microcode, etc.), software (e.g., instructions executing on a processing device), or a combination thereof. It is to be appreciated that not all steps can be needed to perform the disclosure provided herein. Further, some of the steps can be performed simultaneously, or in a different order than shown in FIG. 5, as will be understood by a person of ordinary skill in the art.

For illustrative and non-limiting purposes, method 510 shall be described with reference to FIGS. 1A, 1B, and/or 2. However, method 510 is not limited to those examples.

In operation 512, content server 318 and/or processing module 132 can extract closed caption data from a media stream. In some embodiments, the closed caption data can be a file associated with the media stream, such as metadata 322, concomitantly broadcast with the media stream, or generated live. In some embodiments, at interrogative 514, content server 318 can detect whether a closed caption file is included with the media stream content 320. If a closed caption file is not available, content server 318 can generate a closed caption file in operation 516b. For example, content server 318 can generate a closed caption file using a transcription service. In some embodiments, content server 318 can extract and/or generate closed caption files for a live media stream.

In operation 516a, content server 318 can discern the closed caption content. For example, content server 318 can employ a large language model 328 (referred to as “LLM” in the example of FIG. 3) to understand the closed caption file and identify characteristics of the media stream, including content 320 genre, content 320 personality/actor(s), content 320 director(s), content 320 subject matter, content 320 time length, content 320 country of origin, or any combination thereof.

In operation 518, content server 318 can identify the genre or a theme of the media stream content 320 after extracting and interpreting the closed captioning. For example, content server 318 can identify the media stream content 320 as action, romance, comedy, romantic comedy, horror, children's programming, sports, news, sitcom, soap opera, or the like, based on the extracted closed captioning data. In some embodiments, LLM 328 can be used to detect the overall tone of the media stream content 320. In some embodiments, the tone can include characteristics such as funny, sad, scary, exciting, tender, high-energy, any combination thereof, or any indicating characteristics that will be understood to a person of ordinary skill in the art.

In some embodiments, content server 318 can use a face recognition algorithm (e.g., ACR, CLIP) to identify portrait images in the media stream content 320. For example, content server 318 can use the face recognition algorithm to identify main characters of the content 320, identify popular actors in the content 320, or any indicating characteristics that will be understood to a person of ordinary skill in the art.

In operation 520, content server 318 can extract a random sample of images and/or short clips from the media stream. In some embodiments, the image extraction can be performed per the methods described in the example of FIG. 3. Briefly, content server 318 can identify a plurality of potential supplemental content items (e.g., images, still frames, and/or clips) from within the media stream. The potential supplemental content items can represent possible frames or clips in the media stream for inserting supplemental content into the media stream menu interface (e.g., a streaming service home screen).

In operation 522, content server 318 can identify the plurality of potential supplemental content items in the media stream based on predetermined characteristics generated by content server 318. For example, content server 318 can identify potential supplemental content items in the media stream by way of the regression model 324 described previously in the example of FIG. 4, that can be indicative of the genre of the media stream content 320 (e.g., as determined in step 518), actors portraying characters in the media stream content 320 (e.g., as determined in step 518 using a face recognition algorithm), locale or setting of the media stream content 320, image quality, image theme, image sentiment, any combination thereof, or any indicating characteristics that will be understood to a person of ordinary skill in the art. Content server 318 can then store the potential supplemental content items in main memory 258, secondary memory 260, and/or metadata 322.

In some embodiments, content server 318 can assign tags based on the results of running the regression model 324 to the potential supplemental content items (e.g., data indicators associated with the potential optimal supplemental content that can indicate to content server 318 what characteristics are associated with the potential optimal supplemental content). Content server 318 can then build a set of clustered potential supplemental content items having similar characteristics according to the predetermined characteristics (e.g., genre, locale/setting, actor(s), director(s), funny, scary, sad, etc.). Based on the tags, content server 318 can chose a best match supplemental content item that identifies the media stream content 320 for positioning in the menu interface. In other words, content server 318 can provide user 303 a glimpse of the content 320 to entice user 303 to consume content 320.

In some embodiments, after a best match supplemental content item is identified, content server 318 can use an image upscaling model to enhance, clarify, sharpen, soften, brighten, adjust contrast, or any characteristic that will be understood to a person of ordinary skill in the art that can be altered to provide a higher quality image if needed. In some embodiments, the higher quality image can be stored in, e.g., metadata 322.

In some embodiments, content server 318 can select a subset of media devices 304 based on the characteristics of the clustered potential supplemental content items, as well as the characteristics of media devices 304, as described previously in the example of FIG. 3. Content server 318 can output the set of clustered images to the subset of media devices 304 according to the tags associated with the potential supplemental content item(s). In some embodiments, content server 318 can receive an indication from each media device 304 of the subset of media devices 304 that specifics whether the respective media device 304 outputted the optimal supplemental content and positioned the potential optimal supplemental content item in the menu interface display.

### Automatic Analysis and Dynamic Selection (Creation) of High Quality Supplemental Content for User Engagement Optimization

As discussed above, referring to FIGS. 1A, 1B, 2, and 3, a content 320 source (e.g., content server 318) can transmit a media stream to a media system 302 (e.g., media device 304 and/or display device 306 that can be connected via link 314) through network 316. The content server 318 can insert supplemental content into the media stream menu interface and/or preview page, e.g., for displaying as part of the menu interface as the cover or associated text, pictures, holograms, videos, short videos, or trailers for a program. The inserted supplemental content items may be displayed on display device 106 such as a monitor, TV, computer, smart phone, tablet, wearable (such as a watch or glasses), appliance, IoT device, and/or projector. To maximize user engagement and consumption of content 320 by the user 303 of the media device 304, the content server 318 can determine high quality supplemental content items to insert into the media stream menu interface or use an artificial intelligence (AI) tool (e.g., LLM 328) to generate high quality supplemental content items when no high quality supplemental content item exists for the media stream. In some embodiments, the content server 318 determines or generates the high quality supplemental content items to place into the media stream menu interface using various features derived from various machine learning and/or artificial intelligence models.

In some embodiments, processing module 132 and/or content server 318 can be configured to perform the methods described herein. In further embodiments, the methods described herein can be performed in a cloud computing environment. For example, content server 318 can be configured to perform a computer-implemented method for selecting or generating high quality supplemental content items for use in the menu interface screen of a media streaming service. In some embodiments, as used herein, “supplemental content item” refers to content such as text, an image (e.g., still frame), a hologram, a graphics interchange format (GIF), videos, or a short clip, e.g., extracted from a media stream or program such as a movie, a television show, a live broadcast, etc., and shown adjacent to the title of the media stream content 320 to entice viewers to click on and watch the media stream. For example, the methods described herein can extract and/or identify user engaging features from existing supplemental content items or the media stream based on presenting supplemental content items with the features corresponding to a user 303 or a group of users 303.

In some embodiments, the content server 318 and/or the processing module 132 can be configured to determine whether a quality of at least one of existing supplemental content items associated with a program exceeds a predetermined supplemental content quality threshold. If the quality of at least one of the existing supplemental content items exceeds the predetermined supplemental content quality threshold, the content server 318 and/or the processing module 132 may identify the supplemental content items having a quality that is greater than the predetermined quality threshold (e.g., high quality supplemental content items). Existing supplemental content items may be provided by media provider (e.g., content owner or content distributer), third parties (e.g., individuals or organizations that provide supplemental content for programs) that generate supplemental content for the programs, etc.

As used herein, a “quality” of an existing supplemental content item may be determined based on objective quality attributes such as, but not limited to, the sharpness, noise, dynamic range, tone reproduction, contrast, color accuracy, distortion, exposure accuracy, color fringing, and/or veiling glare of image(s) from the supplemental content item. Alternatively or additionally, the “quality” of the existing supplemental content item may be determined based on subjective quality attributes such, but not limited to, as whether the supplemental content item represents a theme or sentiment of the program, whether the supplemental content item comprises aesthetic pictures, and/or whether the supplemental content item is age appropriate. In some embodiments, an AI tool can be utilized to determine the quality of a supplemental content item. In some embodiments, the content server 318 and/or the processing module 132 can analyze the identified supplemental content items to extract potential engaging features, e.g., using a machine learning (ML) model and/or LLMs (e.g., LLM 328).

On the other hand, if the quality of none of the existing supplemental content items exceeds the predetermined supplemental content quality threshold, the content server 318 and/or the processing module 132 may analyze at least part of the existing supplemental content items to extract engaging features, e.g., using statistical methods, heuristic methods, ML models, LLMs, AI tools (e.g., specialized AI models), or a combination thereof.

Specifically, content server 318 can perform ACR on the (identified) supplemental content items, thereby extracting potential engaging features in the supplemental content items. Content server 318 can then store the extracted potential engaging features in main memory 258, secondary memory 260, and/or metadata 322.

The various statistical methods, heuristic methods, ML models, LLMs, and/or specialized AI models may be off the shelf or custom developed. In some embodiments, a robust system may be built using various statistical methods, heuristic methods, ML models, LLMs, and/or specialized AI models at various stages of the system. In some embodiments, the identified supplemental content items may be fed into prompts of generative AI software to detect various potential engaging features of images of the supplemental content items. A complex routing mechanism may be built as a combination of the various ML models, LLMs, and/or specialized vision AI models to take various subjective and/or objective components or attributes from images of the supplemental content items.

The potential engaging features may include face related features, text related features, theme related features, etc. The face related features may include animated/human faces, face of a celebrity or not, face of a main/supporting actor, face of a celebrity main/supporting actor, the number of faces present, the number of actor faces present, the number of main and secondary actor faces present, emotions in their face, coverage of face in the overall supplemental content, etc. A database storing faces of celebrities may be utilized to identify celebrity faces. The text related features may include the presence/absence of title text, the presence/absence of other text, language of the text, coverage of the text, font of the text, size of the text, location of text, etc. The theme related features may include the matching of genre to supplemental content sentiment, whether the supplemental content aligns with the title and description of the program, etc.

In some embodiments, the content server 318 (e.g., LLM 328) and/or the processing module 132 can categorize the extracted potential engaging features into various feature categories. The various feature categories may include the various types of face related features, text related features, and theme related features as discussed above. The feature categories may be dynamically updated based on the operations (to be discussed) of testing the features categories, e.g., using a multivariate test.

In some embodiments, the content server 318 and/or the processing module 132 can employ the LLM 328 to build feature categories for (identified) supplemental content having similar potential engaging features as discussed above. The categories can be stored in the memory (e.g., storage 132 and/or metadata 322 in content server 318) such that supplemental content items associated with high quality feature categories can be retrieved from the memory and transmitted to media device 304 for output to the media stream menu interface (e.g., the media streaming service menu screen) in the example of the feature categories being built in content server 318. Optionally, in some embodiments the feature categories can be built and stored in media device 304. In some embodiments, a (identified) supplemental content item being assigned a feature category can be marked by the content server 318 and/or the processing module 132, e.g., by way of LLM 328. Marking the (identified) supplemental content item can be performed by adding a tag (e.g., a line of data showing a feature category of the supplemental content item) to the supplemental content item file and storing the supplemental content item file in, for example, storage 136 and/or content server 318.

In some embodiments, the content server 318 and/or the processing module 132 can present to an individual user or a group of users supplemental content items associated with the potential engaging features. The presented supplemental content items may be a subset of the identified supplemental content items in the case of existing high quality supplemental content or a subset of existing supplemental content items in the case of no existing high quality supplemental content. The individual user and/or group of users may be selected based on a predefined standard, e.g., based on demographic information, behavior information, customer data, psychographic information, and/or technographic information. Demographic information may include demographic and/or statistical traits such as age, gender, religion, income, and education. Behavior information may include historical behavior of the users of the media devices 304 (e.g., historical playback information). Customer data may include preferences, seasonal trends, usage history of the media devices 304, etc. Psychographic information may include personality, lifestyle preferences, and social status such as sports preferences, values, volunteering, recreation, etc. Technographic information may include users' technology preferences and/or tools they use. For example, the device (media device 104 and/or display device 106, such as a personal computer or smartphone) a user uses to access the program and/or the operating system of the device.

In some embodiments, the content server 318 and/or the processing module 132 can conduct a test such as, but not limited to, a multivariate testing (e.g., an A/B study) on the potential engaging features with various hypotheses while presenting the users supplemental content items associated with the potential engaging features. For example, the hypotheses may include supplemental content with face present at least once is more engaging than supplemental content without any face, supplemental content with only the main actor's face present is more engaging than supplemental content without any face, supplemental content with one actor face present is more engaging than supplemental content with three or more face present, supplemental content with less than 20% text area coverage is more engaging, supplemental content with Spanish language is more engaging in Mexico, etc.

The content server 318 can measure the efficacies of the potential supplemental content items by receiving information from the plurality media devices 304 over network 316. For example, the content server 318 can receive an indication from each media device 304 of the plurality media devices 304. The indication can specify whether a user of the respective media device 304 watched or listened through (e.g., based on a streaming time) the selected content 320 based on the supplemental content associated with the potential engaging features pushed to the media stream menu interface on each media device 304.

In some embodiments, the content server 318 and/or the processing module 132 can calculate a user engagement metric for each of the feature categories based on the presenting, testing, and/or measuring. As used herein, a “user engagement metric” for a feature category represents user engagement in response to being presented a supplemental content item associated with the feature category. The user engagement metric is calculated based on user engagement or interaction with a program such as, but not limited to, a conversion rate, a click-through rate (CTR), a sentiment of a user (e.g., tracked using a sensor with user permission), a streaming time, a bounce rate (the rate of only watching a program for a short period before changing to something else), or another kind of user engagement metric as would be appreciated by a person of ordinary skill in the art.

Specifically, an image having a face may be found to be more engaging than not, an image having two faces may be more engaging than one face, or an image having text on the bottom of the image may be more engaging than having text on the side of image.

In some embodiments, the content server 318 and/or the processing module 132 can identify a subset of the feature categories for the user or the group of users based on a predetermined user engagement metric threshold. For example, the user engagement metric for a feature category may be compared with the user engagement metric threshold and if the user engagement metric is equal to or greater than the user engagement metric threshold, the feature category may be identified and/or selected as a high quality and/or engaging feature category.

In some embodiments, content server 318 and/or the processing module 132 can determine a threshold for user engagement metric to select engaging supplemental content items from existing supplemental content items. For example, the predetermined user engagement metric threshold (e.g., a minimum user engagement metric) can be 3%. Accordingly, in some embodiments, a supplemental content item (associated with potential engaging features belonging to a feature category) being assigned a user engagement metric value greater than or equal to the threshold value can be marked as engaging supplemental content by the content server 318 and/or the processing module 132, by way of LLM 328. Marking the supplemental content item can be performed by adding a tag (e.g., a line of data showing an engaging feature category) to the supplemental content item file and storing the supplemental content item file in, for example, storage 136 and/or content server 318.

This way, personalized engaging feature category may be identified dynamically for the user or the group of users. The one or more personalized engaging feature category can represent entice the user or group of users to at least click on the media stream title. Specifically, a face of a celebrity main actor covering 30% of an image, text on the bottom of the image, and/or a happy sentiment may be found to be engaging feature categories for a group of urban-dwelling, mid-aged female users.

Based on the results of the content server 318 assigning a user engagement metric value greater than or equal to the user engagement metric threshold value, the content server 318 can build a sample of engaging supplemental content from the images having the user engagement metric value greater than or equal to the user engagement metric threshold value in the media stream and store the sample of engaging supplemental content in the memory (e.g., storage 136 and/or content server 318). In some other embodiments, the content server 318 may assign a user engagement metric value less than or equal to the user engagement metric threshold value, build a sample of engaging supplemental content from the images having the user engagement metric value less than or equal to the user engagement metric threshold value in the media stream, and/or store the sample of engaging supplemental content in the memory (e.g., storage 136 and/or content server 318)

In some embodiments, the content server 318 and/or the processing module 132 can transmit supplemental content items associated with features belonging to the subset of the feature categories (e.g., the sample of engaging supplemental content) to media devices associated with the user or the group of users. In the case of no existent high quality supplemental content, the content server 318 and/or the processing module 132 can generate a supplemental content item having features belonging to the identified subset of the feature categories based on raw media stream files, e.g., using an AI tool. In some embodiments, the content server 318 and/or the processing module 132 can transmit the generated supplemental content item to the media devices associated with the user or the group of users.

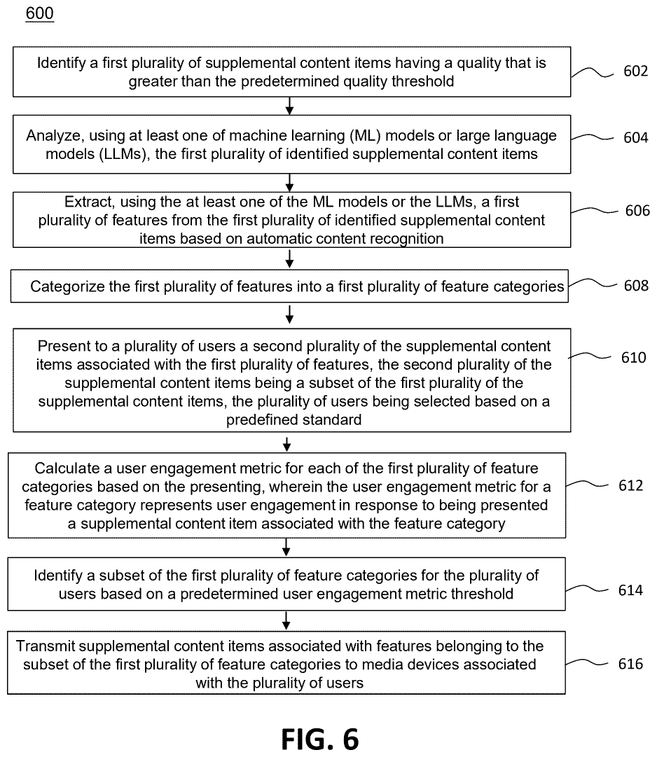

FIG. 6 illustrates a method 600 for automatically analyzing and dynamically selecting high quality supplemental content (an image, a graphics interchange format (GIF), and/or a short clip associate with a media stream content 320) to insert the high quality supplemental content into a media stream menu interface (e.g., a streaming service home screen) and/or preview page to maximize user engagement and consumption of the media stream content 320 by users, according to some embodiments. Method 600 can be performed by processing logic that can comprise hardware (e.g., circuitry, dedicated logic, programmable logic, microcode, etc.), software (e.g., instructions executing on a processing device), or a combination thereof. It is to be appreciated that not all steps can be needed to perform the disclosure provided herein. Further, some of the steps can be performed simultaneously, or in a different order than shown in FIG. 6, as will be understood by a person of ordinary skill in the art.

For illustrative and non-limiting purposes, method 600 shall be described with reference to FIGS. 1A, 1B, and/or 2. However, method 600 is not limited to those examples.

In step 602, content server 318 and/or processing module 132 can identify a first plurality of supplemental content items having a quality that is greater than the predetermined quality threshold. In some embodiments, this can be performed after determining a quality of at least one of existing supplemental content items for a program exceeds a predetermined threshold for supplemental content quality. In other words, after determining at least one existing supplemental content item is of high quality, the high quality existing supplemental content items can be identified. A supplemental content may refer to an image (e.g., still frame), a GIF, a short clip, or any combination thereof. The supplemental content item can be extracted from and/or made with components or frames from a media stream or program (e.g., a movie, a television show, a live broadcast, etc.)

The quality may be determined based on one or more objective and/or subjective attributes. Objective quality attributes may include the sharpness, noise, dynamic range, tone reproduction, contrast, color accuracy, distortion, exposure accuracy, color fringing, and veiling glare of image(s) from a supplemental content item. Subjective quality attributes may include whether the supplemental content item represents a theme or sentiment of the program, whether the supplemental content item comprises aesthetic pictures, and whether the supplemental content item is age appropriate. In some embodiments, content server 318 can utilize an AI, ML, statistical, and/or heuristics tool such as LLM 328 to determine the quality of a supplemental content item.

In step 604, content server 318 and/or processing module 132 can analyze the first plurality of supplemental content items using one or more statistical methods, heuristic methods, machine learning (ML) models, AI tools, or large language models (LLMs), e.g., in order to extract potential engaging features from the first plurality of supplemental content items. For example, content server 318 may build a robust system may using various statistical methods, heuristic methods, AI tools, ML models, LLMs, and/or specialized AI models (e.g., AI image analysis tools) at various stages of the system. The various statistical methods, heuristic methods, AI tools, ML models, LLMs, and/or specialized AI models may be off the shelf or custom developed. The various ML models, LLMs, and/or specialized vision AI models may be tested and/or the optimal model may be utilized for a corresponding stage of the system. For example, a first LLM may be used to detect whether a face is present in an image while a second LLM may be used to detect the emotion of the face. In some embodiments, the first plurality of supplemental content items may be fed into prompts of generative AI software to detect various potential engaging features of content such as images of the supplemental content items. Content server 318 may build a complex routing mechanism as a combination of the various ML models, LLMs, and/or specialized AI models to take various subjective components, objective components and/or attributes from images of the supplemental content items.

In step 606, content server 318 and/or processing module 132 can extract a first plurality of features from the first plurality of supplemental content items based on automatic content recognition (ACR) using the at least one of the statistical methods, heuristic methods, ML models, AI tools, or LLMs. The first plurality of features may be the potential engaging features as discussed above and may include face related features, text related features, theme related features, etc.

In step 608, content server 318 and/or processing module 132 can categorize the first plurality of features into a first plurality of feature categories. For example, the first plurality of features may be categorized into face related features, text related features, theme related features, etc. The face related features may be further categorized into feature subcategories associated with animated/human faces, face of a celebrity or not, face of a main/supporting actor, face of a celebrity main/supporting actor, the number of faces present, the number of actor faces present, the number of main and secondary actor faces present, emotions in their face, coverage of face in the overall supplemental content, etc. Content server 318 may use a database storing faces of celebrities to identify celebrity faces. The text related features may be further categorized into feature subcategories associated with the presence/absence of title text, the presence/absence of other text, language of the text, coverage of the text, font of the text, size of the text, location of text, etc. The theme related features may be further categorized into feature subcategories associated with the matching of genre to supplemental content sentiment, whether the supplemental content aligns with the title and description of the program, etc.

In some embodiments, the content server 318, the processing module 132, and/or the media device 304 can build feature categories for the first plurality of supplemental content items having similar potential engaging features. The content server 318 and/or the media device 304 can employ the LLM 328 to build feature categories for the first plurality of supplemental content items having similar potential engaging features. The categories can be stored in the memory (e.g., storage 132 and/or metadata 322 in content server 318) such that supplemental content items associated with high quality feature categories can be retrieved from the memory and transmitted to media device 304 for output to the media stream menu interface (e.g., the media streaming service menu screen) in the example of the feature categories being built in content server 318. Optionally, in some embodiments the feature categories can be built and stored in media device 304. In some embodiments, a (identified) supplemental content item being assigned a feature category can be marked by the content server 318 and/or the processing module 132, e.g., by adding a tag (e.g., a line of data showing a feature category of the supplemental content item) to the supplemental content item file and storing the supplemental content item file in, for example, storage 136 and/or as content server 318.

In step 610, content server 318 and/or processing module 132 can present to a plurality of users a second plurality of the supplemental content items associated with the first plurality of features. In some embodiments, the second plurality of the supplemental content items can be a subset of the first plurality of the supplemental content items and the plurality of users can be selected based on a predefined standard. The predefined standard may be determined based on one or more of, e.g., demographic information, behavior information, customer data, psychographic information, and technographic information of the plurality of users. In other words, the plurality of users can be selected using the predefined standard that is determined based on at least one of demographic information, behavior information, customer data, psychographic information, and/or technographic information of the plurality of users.

In some embodiments, the content server 318 can conduct a test, e.g., a multivariate testing such as an A/B study on the potential engaging features with various hypotheses while presenting the users the second plurality of the supplemental content items. The hypotheses may include various pairs of hypotheses, e.g., with only one variable at a time or multiple variables at a time. The content server 318 can measure the efficacies of the second plurality of the supplemental content items by receiving information (e.g., a streaming time) from the plurality media devices 304 over network 316.

In step 612, content server 318 and/or processing module 132 can calculate a user engagement metric for each of the first plurality of feature categories based on the presenting. The user engagement metric for a feature category may represent user engagement in response to being presented a supplemental content item associated with the feature category and may be calculated based on one or more of metrics obtained from user interaction such as, but not limited to, a conversion rate, a click-through rate (CTR), a sentiment of a user (e.g., tracked using a sensor with user permission), a streaming time, or a bounce rate (the rate of only watching a program for a short period before changing to something else).

In step 614, content server 318 and/or processing module 132 can identify a subset of the first plurality of feature categories for the plurality of users based on a predetermined user engagement metric threshold. When the user engagement metric for a feature category is equal to or greater than the user engagement metric threshold, the feature category may be identified and/or selected as a high quality/engaging feature category. The user engagement metric threshold may be first predetermined and later dynamically adjusted, e.g., based on the group of the users, the multivariate testing results, the program (such as the genre of the program), etc.

In step 616, content server 318 and/or processing module 132 can transmit supplemental content items associated with features belonging to the subset of the first plurality of feature categories to media devices associated with the plurality of users. When the supplemental content items associated with features belonging to the subset of the first plurality of feature categories are identified, content server 318 may transmit one or more of the supplemental content items to media devices associated with the plurality of users.

The content server 318 can select a particular one of the many supplemental content items associated with features belonging to the subset of the feature categories for transmission to media device(s) 304 associated with the plurality of users. For example, the content server 318 can select a supplemental content item that has the highest user engagement metric. In other words, the content server 318 can select a high quality supplemental content item that best engages the plurality of users independent of any particular feature category (e.g., face related feature, text related feature, theme related feature, etc.).

The content server 318 can also select a particular supplemental content item for transmission to media device(s) 304 based on a particular feature category. For example, content server 318 can select a supplemental content item that has the highest user engagement metric in the feature category of face related features. The content server 318 can also select a supplemental content item that has the highest user engagement metric in the feature category of text related features. The content server 318 can also select a supplemental content item that has the highest user engagement metric in the feature category of theme related features. In other words, the content server 318 can determine different weights for the different feature categories independent of raw user engagement metric values. The content server 318 can select a supplemental content item that is determined engaging for the plurality of users based on various other characteristics as would be appreciated by a person of ordinary skill in the art.

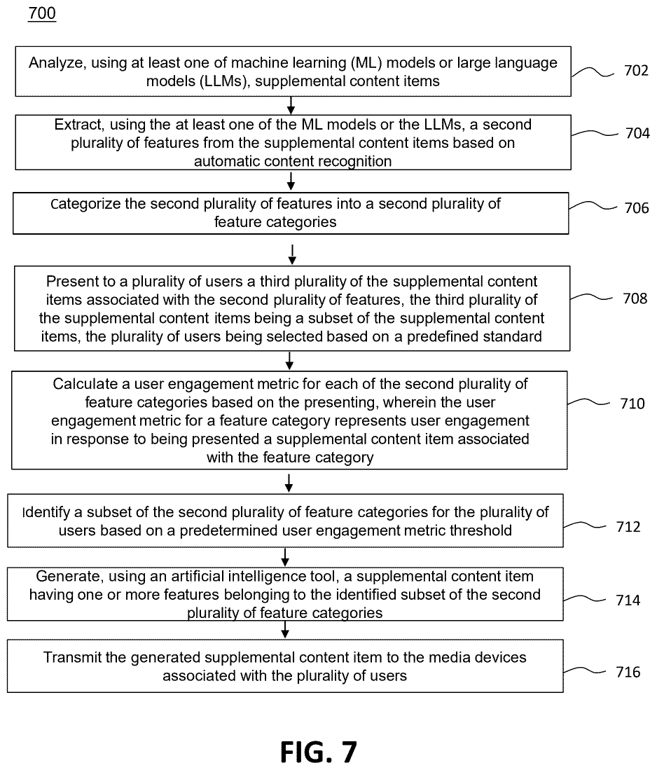

FIG. 7 illustrates a method 700 for automatically analyzing and dynamically generating high quality supplemental content (e.g., text, an image, a hologram, a graphics interchange format (GIF), a video, and/or a short clip associate with a media stream content 320) to insert the high quality supplemental content into a media stream menu interface (e.g., a streaming service home screen) and/or preview page to maximize user engagement and consumption of the media stream content 320 by users, according to some embodiments. Method 700 can be performed by processing logic that can comprise hardware (e.g., circuitry, dedicated logic, programmable logic, microcode, etc.), software (e.g., instructions executing on a processing device), or a combination thereof. It is to be appreciated that not all steps can be needed to perform the disclosure provided herein. Further, some of the steps can be performed simultaneously, or in a different order than shown in FIG. 7, as will be understood by a person of ordinary skill in the art.

For illustrative and non-limiting purposes, method 700 shall be described with reference to FIGS. 1A, 1B, and/or 2. However, method 700 is not limited to those examples.

In step 702, content server 318 and/or processing module 132 can analyze the supplemental content items using at least one of the statistical methods, heuristic methods, ML models, AI tools, or LLMs. In some embodiments, this can be performed after determining a quality of none of existing supplemental content items for a program exceeds a predetermined threshold for supplemental content quality. In other words, after determining none of the existing supplemental content item is of high quality, the existing supplemental content items can be analyzed, e.g., to extract potential engaging features.

In step 704, content server 318 and/or processing module 132 can extract a second plurality of features from the supplemental content items based on automatic content recognition (ACR) using the at least one of the statistical methods, heuristic methods, ML models, AI tools, or LLMs. In operation 706, content server 318 and/or processing module 132 can categorize the second plurality of features into a second plurality of feature categories. In operation 708, content server 318 and/or processing module 132 can present to the plurality of users a third plurality of the supplemental content items associated with the second plurality of features, wherein the third plurality of the supplemental content items are a subset of the supplemental content items.

In step 710, content server 318 and/or processing module 132 can calculate a user engagement metric for each of the second plurality of feature categories based on the presenting. In operation 712, content server 318 and/or processing module 132 can identify a subset of the second plurality of feature categories for the plurality of users based on the predetermined user engagement metric threshold.

In step 714, content server 318 and/or processing module 132 can generate a supplemental content item having one or more features belonging to the identified subset of the second plurality of feature categories, e.g., using an AI tool. In some embodiments, the content server 318 can select a particular one of the many features belonging to the identified subset of the second plurality of feature categories for generating the supplemental content item. For example, the content server 318 can select a feature from a feature category that has the highest user engagement metric. In other words, the content server 318 can generate a high quality supplemental content item that best engages the plurality of users independent of any particular feature category (e.g., face related feature, text related feature, theme related feature, etc.).

The content server 318 can also select a particular feature for generating the supplemental content item based on a particular feature category, similar to how the content server 318 can select a particular supplemental content item for transmission to media device(s) 304 based on a particular feature category as discussed earlier in operation 616. The content server 318 can select a particular feature for generating the supplemental content item based on various other characteristics as would be appreciated by a person of ordinary skill in the art.

In step 716, content server 318 and/or processing module 132 can transmit the generated supplemental content item to the media devices associated with the plurality of users.

By automating supplemental content selection and creation, embodiments reduce manual effort and time required to create personalized high quality, engaging artwork for individual users or groups of users. The AI-based approach disclosed herein can maintain a high standard across various content types, ensuring that supplemental content such as, but not limited to, text, artwork, holograms, GIFs, videos, shorts, and trailers consistently reflect the video stream's theme and appeal while improving user engagement.

### CONCLUSION

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

What is claimed is:

1. A computer-implemented method for selecting or generating high quality supplemental content for a program, comprising:
in response to determining, by at least one computer processor, a quality of at least one of supplemental content items exceeds a predetermined supplemental content quality threshold:
identifying a first plurality of supplemental content items having a quality that is greater than the predetermined supplemental content quality threshold;
analyzing, using at least one of machine learning (ML) models or large language models (LLMs), the first plurality of supplemental content items;
extracting, using the at least one of the ML models or the LLMs, a first plurality of features from the first plurality of supplemental content items based on automatic content recognition;
categorizing the first plurality of features into a first plurality of feature categories;
presenting to a plurality of users a second plurality of the supplemental content items associated with the first plurality of features, the second plurality of the supplemental content items being a subset of the first plurality of the supplemental content items, the plurality of users being selected based on a predefined standard;
calculating a user engagement metric for each of the first plurality of feature categories based on the presenting, wherein the user engagement metric for a feature category represents user engagement in response to being presented a supplemental content item associated with the feature category;
identifying a subset of the first plurality of feature categories for the plurality of users based on a predetermined user engagement metric threshold; and
transmitting supplemental content items associated with features belonging to the subset of the first plurality of feature categories to media devices associated with the plurality of users.

2. The computer-implemented method of claim 1, further comprising:
in response to determining a quality of none of the supplemental content items exceeds the predetermined supplemental content quality threshold:
analyzing using at least one of the ML models or the LLMs, the supplemental content items;
extracting using the at least one of the ML models or the LLMs, a second plurality of features from the supplemental content items based on automatic content recognition;
categorizing the second plurality of features into a second plurality of feature categories;
presenting to the plurality of users a third plurality of the supplemental content items associated with the second plurality of features, the third plurality of the supplemental content items being a subset of the supplemental content items;
calculating a user engagement metric for each of the second plurality of feature categories based on the presenting;
identifying a subset of the second plurality of feature categories for the plurality of users based on the predetermined user engagement metric threshold;
generating, using an artificial intelligence tool, a supplemental content item having one or more features belonging to the identified subset of the second plurality of feature categories; and
transmitting the generated supplemental content item to the media devices associated with the plurality of users.

3. The computer-implemented method of claim 1, wherein the at least one of the supplemental content items comprises one of an image, a graphics interchange format (GIF), or a video clip.

4. The computer-implemented method of claim 1, wherein the feature category comprises a face related feature, a text related feature, or a theme related feature.

5. The computer-implemented method of claim 1, wherein the user engagement metric is calculated based on at least one of a conversion rate, a click-through rate (CTR), a sentiment of a user, or a streaming time.

6. The computer-implemented method of claim 1, wherein the presenting comprises conducting a multivariate testing on the first plurality of features with a plurality of hypotheses.

7. The computer-implemented method of claim 1, wherein the predefined standard for selecting the plurality of users is based on at least one of behavior information, customer data, demographic information, psychographic information, or technographic information.

8. A system for selecting or generating high quality supplemental content for a program, comprising:
one or more memories; and
at least one computer processor coupled to at least one of the memories and configured to perform operations comprising:
in response to determining a quality of at least one of supplemental content items exceeds a predetermined supplemental content quality threshold:
identifying a first plurality of supplemental content items having a quality that is greater than the predetermined supplemental content quality threshold;
analyzing, using at least one of machine learning (ML) models or large language models (LLMs), the first plurality of supplemental content items;
extracting, using the at least one of the ML models or the LLMs, a first plurality of features from the first plurality of supplemental content items based on automatic content recognition;
categorizing the first plurality of features into a first plurality of feature categories;
presenting to a plurality of users a second plurality of the supplemental content items associated with the first plurality of features, the second plurality of the supplemental content items being a subset of the first plurality of the supplemental content items, the plurality of users being selected based on a predefined standard;
calculating a user engagement metric for each of the first plurality of feature categories based on the presenting, wherein the user engagement metric for a feature category represents user engagement in response to being presented a supplemental content item associated with the feature category;
identifying a subset of the first plurality of feature categories for the plurality of users based on a predetermined user engagement metric threshold; and
transmitting supplemental content items associated with features belonging to the subset of the first plurality of feature categories to media devices associated with the plurality of users.

9. The system of claim 8, wherein the at least one computer processor is further configured to perform operations comprising:
in response to determining a quality of none of the supplemental content items exceeds the predetermined supplemental content quality threshold:
analyzing, using at least one of the ML models or the LLMs, the supplemental content items;
extracting, using the at least one of the ML models or the LLMs, a second plurality of features from the supplemental content items based on automatic content recognition;
categorizing the second plurality of features into a second plurality of feature categories;
presenting to the plurality of users a third plurality of the supplemental content items associated with the second plurality of features, the third plurality of the supplemental content items being a subset of the supplemental content items;
calculating a user engagement metric for each of the second plurality of feature categories based on the presenting;
identifying a subset of the second plurality of feature categories for the plurality of users based on the predetermined user engagement metric threshold;
generating, using an artificial intelligence tool, a supplemental content item having one or more features belonging to the identified subset of the second plurality of feature categories; and
transmitting the generated supplemental content item to the media devices associated with the plurality of users.

10. The system of claim 8, wherein the at least one of the supplemental content items comprises one of an image, a graphics interchange format (GIF), or a video clip.

11. The system of claim 8, wherein the feature category comprises a face related feature, a text related feature, or a theme related feature.

12. The system of claim 8, wherein the user engagement metric is calculated based on at least one of a conversion rate, a click-through rate (CTR), a sentiment of a user, or a streaming time.

13. The system of claim 8, wherein the presenting comprises conducting a multivariate testing on the first plurality of features with a plurality of hypotheses.

14. The system of claim 8, wherein the predefined standard for selecting the plurality of users is based on at least one of behavior information, customer data, demographic information, psychographic information, or technographic information.

15. A non-transitory computer-readable medium having instructions stored thereon that, when executed by at least one computing device, cause the at least one computing device to perform operations comprising:
in response to determining a quality of at least one of supplemental content items exceeds a predetermined supplemental content quality threshold:
identifying a first plurality of supplemental content items having a quality that is greater than the predetermined supplemental content quality threshold;
analyzing, using at least one of machine learning (ML) models or large language models (LLMs), the first plurality of supplemental content items;
extracting, using the at least one of the ML models or the LLMs, a first plurality of features from the first plurality of supplemental content items based on automatic content recognition;
categorizing the first plurality of features into a first plurality of feature categories;
presenting to a plurality of users a second plurality of the supplemental content items associated with the first plurality of features, the second plurality of the supplemental content items being a subset of the first plurality of the supplemental content items, the plurality of users being selected based on a predefined standard;
calculating a user engagement metric for each of the first plurality of feature categories based on the presenting, wherein the user engagement metric for a feature category represents user engagement in response to being presented a supplemental content item associated with the feature category;
identifying a subset of the first plurality of feature categories for the plurality of users based on a predetermined user engagement metric threshold; and
transmitting supplemental content items associated with features belonging to the subset of the first plurality of feature categories to media devices associated with the plurality of users.

16. The non-transitory computer-readable medium of claim 15, the operations further comprising:
in response to determining a quality of none of the supplemental content items exceeds the predetermined supplemental content quality threshold:
analyzing, using at least one of the ML models or the LLMs, the supplemental content items;
extracting, using the at least one of the ML models or the LLMs, a second plurality of features from the supplemental content items based on automatic content recognition;
categorizing the second plurality of features into a second plurality of feature categories;
presenting to the plurality of users a third plurality of the supplemental content items associated with the second plurality of features, the third plurality of the supplemental content items being a subset of the supplemental content items;
calculating a user engagement metric for each of the second plurality of feature categories based on the presenting;
identifying a subset of the second plurality of feature categories for the plurality of users based on the predetermined user engagement metric threshold;
generating, using an artificial intelligence tool, a supplemental content item having one or more features belonging to the identified subset of the second plurality of feature categories; and
transmitting the generated supplemental content item to the media devices associated with the plurality of users.

17. The non-transitory computer-readable medium of claim 15, wherein the at least one of the supplemental content items comprises one of an image, a graphics interchange format (GIF), or a video clip.

18. The non-transitory computer-readable medium of claim 15, wherein the feature category comprises a face related feature, a text related feature, or a theme related feature.

19. The non-transitory computer-readable medium of claim 15, wherein the user engagement metric is calculated based on at least one of a conversion rate, a click-through rate (CTR), a sentiment of a user, or a streaming time.

20. The non-transitory computer-readable medium of claim 15, wherein the presenting comprises conducting a multivariate testing on the first plurality of features with a plurality of hypotheses.
